(19) United States
(12) Patent Application Publication
(10) Pub. No.: US 2015/0026346 A1
(43) Pub. Date: Jan. 22, 2015

(54) METHOD AND SYSTEM FOR MANAGING CLOUD CENTERS

(71) Applicant: Electronics and Telecommunications Research Institute, Daejeon (KR)

(72) Inventors: Seung Hyun YOON, Daejeon (KR); Byeongsik KIM, Daejeon (KR); Dong Myoung BAEK, Daejeon (KR)

(73) Assignee: Electronics and Telecommunications Research Institute, Daejeon (KR)

(21) Appl. No.: 14/285,097

(22) Filed: May 22, 2014

(30) Foreign Application Priority Data
Jul. 22, 2013 (KR) 10-2013-0086295

(51) Int. Cl. H04L 12/911

(52) U.S. Cl. CPC H04L 47/70; H04L 47/822
USPC 709/226

(57) ABSTRACT

A plurality of local management systems each manage at least one of distributed cloud centers, and generate individual resource information about the cloud centers they manage. A global management system collects individual resource information about the corresponding cloud centers from the plurality of local management systems, and requests cloud center resources while transmitting profile information in a resource container format to the local management systems according to users who have requested a cloud service.

### CROSS-REFERENCE TO RELATED APPLICATION

This application claims priority to and the benefit of Korean Patent Application No. 10-2013-0086295 filed in the Korean Intellectual Property Office on Jul. 22, 2013, the entire contents of which are incorporated herein by reference.

### BACKGROUND OF THE INVENTION

(a) Field of the Invention

The present invention relates to a method and system for managing cloud centers.

(b) Description of the Related Art

A cloud computing service is a service that provides a computing environment where one can simultaneously use IT-related services such as data storage, networking, and content through a server on the internet. A cloud center for providing these services consists of a plurality of servers, and provides computing resources to clients.

To run cloud centers, management systems, which are called cloud management platforms (or cloud OSs) present within the cloud centers, are used. Cloud centers are usually increasingly being distributed and installed in various locations, rather than residing in one location, due to a variety of issues such as electricity, regional issues, and networking issues. Particularly, micro IDCs (internet data centers), which involve placing small-scale cloud centers in many locations, are currently under discussion.

Although cloud management systems are capable of managing cloud centers divided into several zones and distributed over these zones, they are confronted with a variety of problems if the management systems are a long distance away from resource elements (servers, storage, and switches).

A cloud management system usually directly manages the physical resources of servers and storage and the resources of virtual servers, virtual storage, and virtual networks in a resource pool, and performs various types of provisioning tasks individually and directly on each device. For safety and immediacy of these tasks, the management system and the physical resources are connected using a dedicated switch and an interface even when they are a short distance from each other (e.g., the management system and the physical resources are built together within the center).

However, when directly controlling the resources (servers, storage, and networks) of a large number of cloud centers, i.e., micro IDCs, which are a long distance away, through a network, there are many issues regarding scalability of cloud management systems, delay of management and control signals, stability/reliability of management networks, and dealing with failures, including how to perform local management of micro IDCs distributed over different locations. Particularly, regional information should be kept in units of resources when allocating resources, with regional characteristics taken into account. This leads to the problem of inefficient resource management in designing or calculating proximity to each service based on this regional information.

### SUMMARY OF THE INVENTION

The present invention has been made in an effort to provide a method and system for efficiently controlling and managing distributed cloud centers when providing a cloud computing service.

An exemplary embodiment of the present invention provides a method for managing distributed cloud centers, the method including: a global management system collecting individual resource information about the cloud centers from a plurality of local management systems that manage the distributed cloud centers; the global management system selecting at least one cloud center, based on the collected individual resource information, according to users who have requested a cloud service; and the global management system requesting cloud center resources while transmitting profile information in a resource container format to the local management systems that manage the selected cloud centers.

The method may further include the local management system summarizing the individual resource information in a form required by the global management system, and transmitting the same to the global management system.

If there is any change, including the installation of new resources, addition or removal of resources, and presence of a defect in the cloud centers managed by the local management systems, the individual resource information may include information related to such change. The individual resource information may further include status information about the cloud centers.

The profile information in the resource container format may include VM (virtual machine) information for creating virtual servers and network setup information that includes one among a networking method for connection to other cloud centers and bandwidth.

In the selecting, at last one cloud center may be selected by taking the regional characteristics of the service and the amounts of resources and locations of the cloud centers into account.

The method may further include: the global management system receiving resource utilization information from each local management system, and classifying the received resource utilization information; the global management system analyzing and classifying the resource utilization information according to service users, cloud center, or resource containers, and storing the result in a global database; and the global management system delivering monitoring information concerning the service provided, which contains the resource utilization information, to the administrator and the relevant user.

Another exemplary embodiment of the present invention provides a method for managing distributed cloud centers, the method including: a local management system managing at least one of the distributed cloud centers and generating individual resource information about the cloud center it manages; the local management system summarizing the generated individual resource information in a preset form and transmitting the same to a global management system that manages the local management system; the local management system receiving profile information in a resource container format from the global management system, in response to a cloud service request from each user; and the local management system controlling the cloud center it manages based on the profile information to provide the cloud service to the user.

The local management system may manage only its own cloud center, and the global management system may manage the cloud center indirectly through the local management system.

In the generating of individual resource information, if there is any change, including the installation of new resources, addition or removal of resources, and presence of a defect in the cloud centers managed by the local management systems, the individual resource information may include information related to such change.

In the providing of the cloud service, the local management system may allocate the resources of the cloud center it manages in response to the cloud service request, based on the profile information, and notify the global management system of the result of the resource allocation.

The method may further include: the local management system obtaining resource utilization information of each cloud center; the local management system analyzing and classifying the resource utilization information according to service users, cloud centers, or resource containers; and the local management system delivering monitoring information concerning the service based on the analyzed and classified information to the administrator and the relevant user.

Yet another exemplary embodiment of the present invention provides a system for managing distributed cloud centers, the system including: a plurality of local management systems that each manage at least one of the distributed cloud centers and generate individual resource information about the cloud center they manage; and a global management system that collects individual resource information about the cloud centers from the plurality of local management systems, and requests cloud center resources while transmitting profile information in a resource container format to the local management systems according to users who have requested a cloud service, wherein each local management system controls the cloud center it manages based on the profile information to provide the cloud service to the user.

The global management system may include: a resource information collection and management part that collects information about the cloud centers from the local management systems; a global database that stores the collected information according to the cloud centers; and a resource container generation part that generates profile information in a resource container format according to users who have requested the service, and requests resources while transmitting the same to the local management systems, the profile information including VM (virtual machine) information for creating virtual servers and network setup information that includes one among a networking method for connection to other cloud centers and bandwidth.

The global management system may further include an information classification part that receives resource utilization information transmitted from the local management systems and classifies and manages the received resource utilization information according to a preset classification system.

The profile information may further include load balancing information including a set value for load balancing, firewall information, and user network information concerning the type of networking used.

The local management system may include: a local management interface part that provides an interface with the outside; an open control interface agent that interfaces with the global management system; and a control and management part that manages the resources of the corresponding cloud center, monitors service use, and processes resource information and status information about the corresponding cloud center and provides the same to the global management system through the open control interface agent.

If there is any change in the resource information due to the installation of new resources, addition or removal of resources, and presence of a defect in the cloud center, the control and management part may generate individual resource information containing related information, and summarize the generated individual resource information in a form required by the global management system and provide the same to the global management system according to a preset cycle, whenever such change occurs, or in response to an instruction from the global management system.

The control and management part may gather the information on utilization of resources of the cloud center for each piece of profile information in a resource container format, and transmit the same to the global management system.

### BRIEF DESCRIPTION OF THE DRAWINGS

FIG. 1 is a view showing a structure of a cloud center management system according to an exemplary embodiment of the present invention.

FIG. 2 is a view showing a structure of a resource container according to the exemplary embodiment of the present invention.

FIG. 3 is a view showing a structure of a global management system according to the exemplary embodiment of the present invention.

FIG. 4 to FIG. 6 are flowcharts of a cloud center management method according to the exemplary embodiment of the present invention.

FIG. 7 is a view showing a structure in which a cloud center management system according to an exemplary embodiment of the present invention is implemented in a computer system.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

Throughout the specification and claims, unless explicitly described to the contrary, the word “comprise” and variations such as “comprises” or “comprising” will be understood to imply the inclusion of stated elements but not the exclusion of any other elements.

Now, a method and system for managing cloud centers according to an exemplary embodiment of the present invention will be described.

In the exemplary embodiment of the present invention, a global management system runs and manages distributed cloud centers either individually or in an integrated way through a hierarchical structure working in conjunction with a local management system. To this end, a cloud management system is run in two separate sections: a global management system and a local management system. The global management system does not directly manage or control individual resources belonging to each of the distributed cloud centers, and allocates service resources in such a manner that it requests abstracted or abridged information and a profile defined as a resource container all at once.

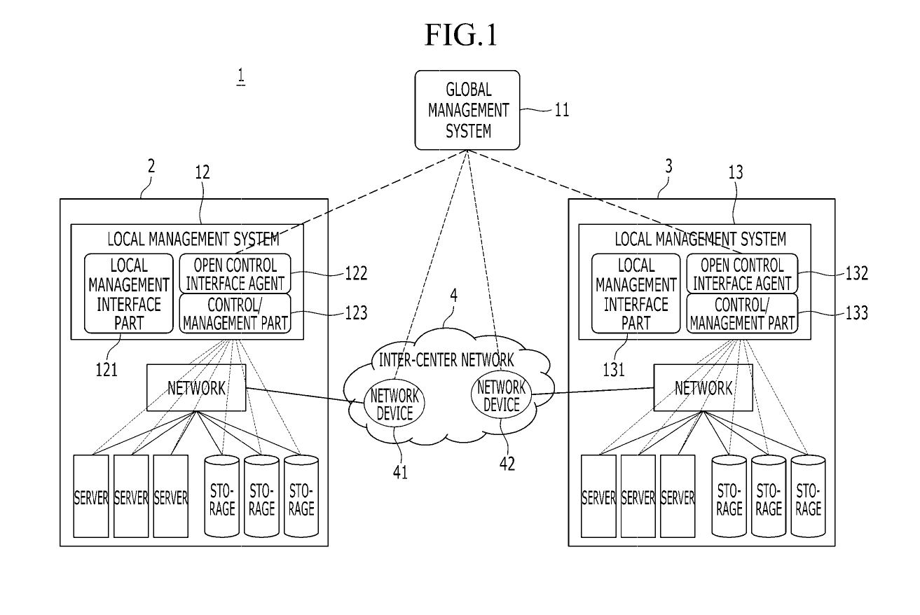

FIG. 1 is a view showing a structure of a cloud center management system according to an exemplary embodiment of the present invention.

As shown in the attached FIG. 1, the cloud center management system 1 according to the exemplary embodiment of the present invention includes a global management system 11 and local management systems 12 and 13.

The local management systems 12 and 13 manage distributed cloud centers 2 and 3 individually. To this end, the local management systems 12 and 13 are located in the distributed cloud centers 2 and 3, respectively. Herein, two cloud centers and two local management systems will be taken as an example for better understanding, but the number of cloud centers is not limited to two.

The local management systems 12 and 13 directly manage and allocate the resources within their cloud centers, and perform a monitoring task, etc. To this end, the local management systems 12 and 13 include local management interface parts 121 and 131, open control interface agents 122 and 132, and control and management parts 123 and 133, respectively.

The local management interface parts 121 and 131 provide interfaces to the outside, and accordingly the administrator can control the resources or services in the cloud centers through the local management interface parts 121 and 131.

The open control interface agents 122 and 132 interface with the global management system 11. The open control interface agents 122 and 132 deliver data or signals from the global management system 11 to the control and management parts 123 and 133, and deliver data or signals from the control and management parts 123 and 133 to the global management system 11.

The control and management parts 123 and 133 manage and control the resources in the cloud centers, and monitor the status and utilization of service-related resources. Particularly, the control and management parts 123 and 133 process resource information and status information about the cloud centers and provide it to the global management system 11.

Each of the distributed cloud centers 2 and 3 includes resources for cloud computing service, and may be a micro IDC (Internet Data Center). If there is any change in the resource information due to the installation of new resources, addition or removal of resources, presence of a defect, etc., the cloud centers 2 and 3 send related information to the global management system 11. Accordingly, the control and management parts 123 and 133 of the local management systems in the cloud centers each collect individual resource information from the cloud centers, and store it in local databases (not shown) for local management. Here, the local databases may be included in the control and management parts or implemented as individual units.

The control and management parts 123 and 133 summarize the collected individual resource information in an abridged form required by the global management system 11, and transmit it to the global management system 11 through the open control interface agents 122 and 132. The control and management parts 123 and 133 may additionally transmit status information about the cloud centers, in addition to the individual resource information. The control and management parts 123 and 133 may periodically transmit resource information and status information. Otherwise, they may provide resource information and status information to the global management system, in case of any change in the resource information, or in response to instructions from the global management system.

The local management systems 12 and 13 having this structure control and manage the resources in their cloud centers, but do not manage or control resources in cloud centers in other regions.

The global management system 11 can manage all the cloud centers within the network, and perform network topology management and resource allocation between them. As shown in FIG. 1, the global management system 11 can set up a network between the cloud centers through network devices 41 and 42 of an inter-center network 4, control network devices of the cloud centers 2 and 3 through the network devices 41 and 42, and allocate network resources.

Upon a service request, the global management system 11 may request at least one cloud center to allocate resources and provide the resources to the user, taking the regional characteristics of the service and the amounts of resources and locations of the cloud centers into account. Regarding a cloud service request, at least one cloud center is selected based on individual resource information collected for each user who has requested the service, and the selected cloud center is requested to allocate resources.

To this end, the global management system 11 works in conjunction with the local management systems 12 and 13 installed in the distributed cloud centers 2 and 3. The global management system 11 does not directly manage or control individual resources belonging to each of the distributed cloud centers, and allocates service resources in such a manner that it requests abstracted or abridged information and a profile defined as a resource container all at once.

To this end, the global management system 11 requests the cloud centers to allocate resources while transmitting profile information in a resource container format to each user, rather than requesting individual resources (e.g., server/virtual servers, storage/virtual storage, etc.) of each cloud center.

The resource container refers to a unit of provisioning and management made in one template. In the exemplary embodiment of the present invention, the resource container may include the settings of a network between the cloud centers (e.g., IDCs or DCs), taking the distributed environment into account.

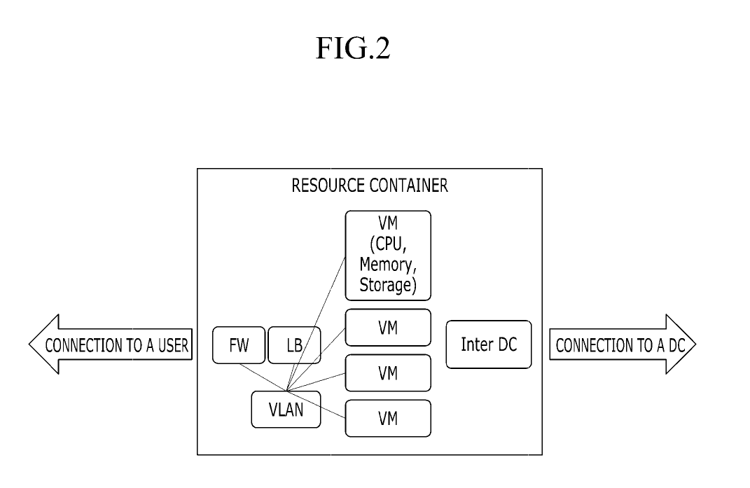

FIG. 2 is a view showing a structure of a resource container according to the exemplary embodiment of the present invention.

This figure depicts a structure of a resource container for an IaaS (Infrastructure as a Service) cloud service.

The IaaS cloud service is usually a service that creates and runs servers, storage, and networks in a virtual environment, and allows the use of resources as required. The IaaS cloud service is provided in combination with a plurality of virtual machines (VMs), a virtual user network (VLAN), a firewall, a load balancer, or an ADC (Application Delivery Controller) such as a NAT (network address translation) function. The VLAN is not limited to the VLAN technology of the Ethernet, and can be replaced by other technologies (e.g., VXLAN, Openflow, etc.).

For the IaaS cloud service, as shown in FIG. 2, the resource container includes VM information, firewall information (FW) for connection to a user client, load balance information (LB), and information for the user's network setup, and in addition, includes network setup information (Inter DC).

The VM information includes information for creating virtual servers such as CPUs, memory, and storage, and the load balance information (LB) includes a set value for load balancing. The firewall information (FW) includes various types of access lists, etc., and the user network information (VLAN) includes the type of networking used (e.g., L2, L3, and Openflow), and can be provided in a generalized form so as to select a networking type. The network setup information (Inter DC) includes setup information, such as a networking method (e.g., L2VPN, L3VPN, IP, etc.) for connection to other cloud centers and bandwidth. If a network device outside a cloud center needs to be controlled for setting up an Inter DC network, the global management system 11 may perform this operation to allocate network resources.

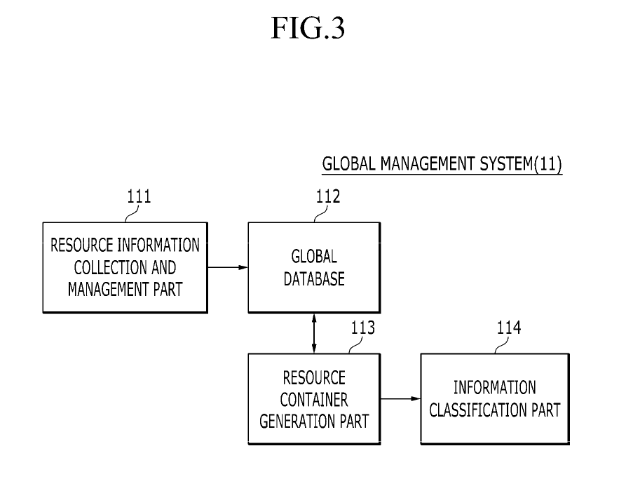

Meanwhile, the global management system 11 has the structure of FIG. 3.

FIG. 3 is a view showing a structure of a global management system according to the exemplary embodiment of the present invention.

As shown in the attached FIG. 3, the global management system 11 according to the exemplary embodiment of the present invention includes a resource information collection and management part 111, a global database 112, a resource container generation part 113, and an information classification part 114.

The resource information collection and management part 111 collects resource information and status information about the cloud centers 2 and 3, and stores and manages it according to the cloud centers. Particularly, the resource information collection and management part 111 receives resource information from the local management systems 12 and 13 located in the cloud centers, and this resource information may be summary information which is an abridged version of individual resource information collected according to the cloud centers.

The global database 112 stores resource information and status information for each cloud center which is collected from each local management system. Besides, the global database 12 stores the location of each cloud center therein.

The resource container generation part 113 generates a resource container template, which is to be provided to each cloud center, to provide service. The resource container may be made in a template with the structure of FIG. 2, and may be generated for each user, i.e., client, who has requested service. The generated resource container template is transmitted to a cloud center selected for service provisioning.

The information classification part 114 receives resource utilization information transmitted from each local management system, and classifies the received resource utilization information according to a preset classification system. For example, resource utilization can be classified according to clients, i.e., users, who have requested service, according to resource containers, or according to cloud centers.

Meanwhile, the global management system 11 may further include a network controller (not shown) that controls network devices located outside the cloud centers and sets up a network between the cloud centers, in addition to the above-described components 111 to 114. The network controller can perform network topology management and resource allocation between the cloud centers.

The cloud centers 2 and 3 include computing resources, i.e., a plurality of servers, a plurality of storage devices, etc., and provide the computing resources to clients (not shown) having different requirements.

Next, a management method according to the exemplary embodiment of the present invention will be described based on the cloud center management system having this structure.

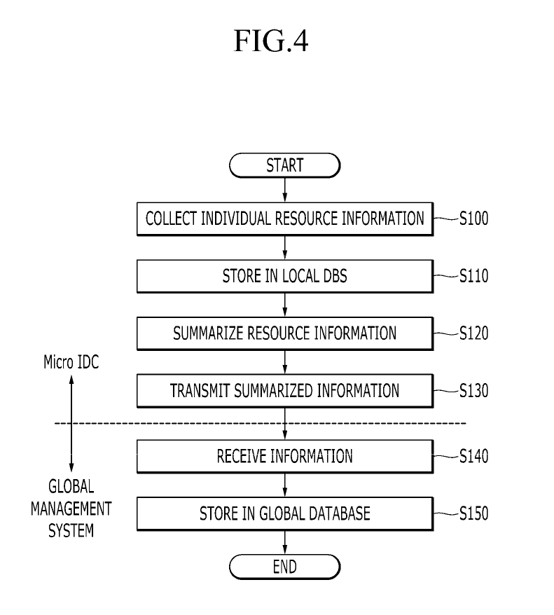

FIG. 4 to FIG. 6 are flowcharts of a cloud center management method according to the exemplary embodiment of the present invention.

First, a resource information collection process of the cloud center management method will be described.

FIG. 4 is a flowchart showing a resource information collection process of the cloud center management method according to the exemplary embodiment of the present invention.

The global management system 11 collects resource information and status information about each of the cloud centers of which it is in charge, before conducting service (S100).

To this end, upon detecting any change in the resource information due to the installation of new resources, addition or removal of resources, presence of a defect, etc. in the cloud centers, the local management systems 12 and 13 located in the distributed cloud centers 2 and 3 collect the resource information about the cloud centers. The collected resource information includes information concerning resources which are newly installed, added, or removed, or are defective.

The local management systems 12 and 13 store the collected resource information in the local databases (S110), and upon completion of the collection, transmit the stored resource information to the global management system 11.

At this time, the local management systems 12 and 13 summarize the resource information in an abridged version required for the global management system 11 (S120), and transmit the summarized resource information to the global management system 11 (S130). Further, the local management systems 12 and 13 may additionally transmit status information, such as the availability of service in the cloud centers, the type of available service, and so on.

As discussed above, the global management system 11 receives the summarized resource information about the cloud centers from the local management systems 12 and 13 (S140), and store the received resource information about the cloud centers in the global database (S150).

Through this procedure, the global management system 11 can collect resource information about each of the distributed cloud centers. The collected resource information is later used as information required for service provisioning or management.

Although the description has been given of a case where information is collected according to change in the resources of the cloud centers, the above-described resource information collection process may be conducted as the global management system 11 instructs the local management systems 12 and 13 to collect resource information.

Next, service provisioning based on the resource information collected as described above will be explained.

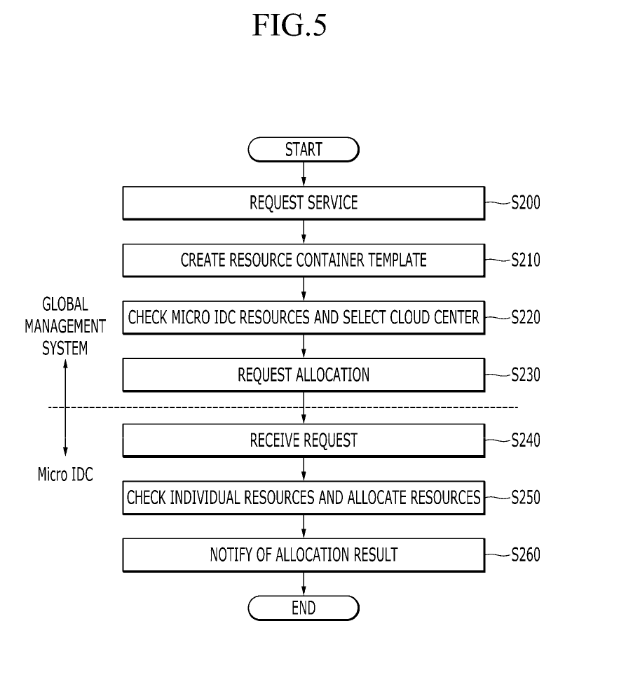

FIG. 5 is a flowchart showing a service provisioning process of the cloud center management method according to the exemplary embodiment of the present invention.

Service provisioning starts upon receiving a service request from a client (S200), and a template for generating a resource container to be delivered to each cloud center is created to provide the service.

The global management system 11 creates a resource container template depending on which service the client has requested (S210), and checks the location and available resources of each cloud center (e.g., micro IDC) and selects a cloud center to which the service is to be assigned (S220). Then, the global management system 11 transmits the resource container template to the selected cloud center, and requests the allocation of resources for the service (S230).

The resource container from the global management system 11 is delivered to the local management system located in the selected cloud center (S240). The local management system 12 or 13 of the selected cloud center allocates the resources in its cloud center, based on the information contained in the resource container delivered from the global management system 11. That is, the local management system 12 or 13 of the selected cloud center checks the individual resources of its cloud center based on the requested resources contained in the resource container, and allocates resources in response to the request (S250). In this case, a server image file for running a virtual server defined in the resource container may be transmitted upon an allocation request from the global management system 11, or preliminarily transmitted to the local management system from the global management system 11.

Thereafter, the local management system 12 or 13 notifies the global management system 11 of the result of the resource allocation (S260).

Next, the collection of billing information for the above-described service provisioning will be explained.

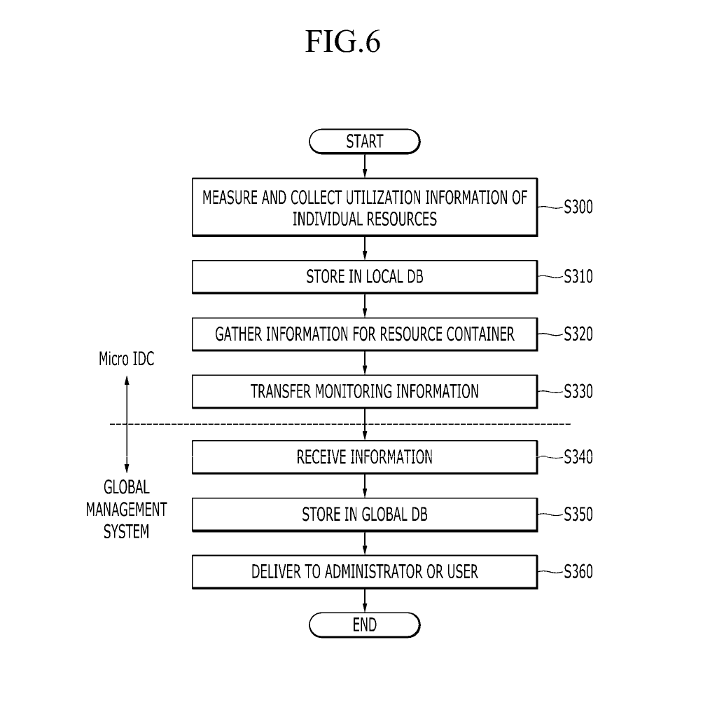

FIG. 6 is a flowchart showing a billing information collection process of the cloud center management method according to the exemplary embodiment of the present invention.

To collect billing/accounting information (hereinafter commonly referred to as “billing information” for convenience of explanation), the utilization of resources in each cloud center is measured and collected (S300). The cloud center measures the utilization of resources used for service provisioning and delivers it to its local management system 12 or 13, and the local management system 12 or 13 stores the resource utilization in the local database (S310).

The local management system 12 or 13 gathers the information on utilization of resources of the cloud center for each resource container delivered from the global management system 11, and transmits it to the global management system 11 (S320, S330). This resource utilization information is used as billing information.

The global management system 11 receives the resource utilization information transmitted from each local management system, and classifies the received resource utilization information (S340). That is, the global management system 11 analyzes and classifies the resource utilization information according to service users, cloud centers, or resource containers, and stores the result in the global database 112 (S350).

Thereafter, the global management system 11 can deliver monitoring information concerning the service provided, which contains the resource utilization information, to the administrator and the relevant user. For example, the monitoring information may be provided periodically or according to a request from the administrator or the relevant user. Moreover, service may be charged based on the information stored in the global database 12.

As the resource information collection process, service provisioning process, and billing information collection process as set forth above apply only to local services, the local management systems may directly perform the above processes and provide local services for local users.

As discussed above, distributed cloud centers are controlled and managed in a distributed and hierarchical manner between the local management systems and the global management system. Thus, the load of management of the cloud centers can be eliminated even when they are scaled up, and the scalability of the management method can be ensured.

According to an embodiment of the present invention, in an environment with distributed cloud centers, the cloud centers can be hierarchically distributed and managed by using a global management system and local management systems distributed and located in the cloud centers. Accordingly, distributed cloud computing management can be made simple. Moreover, even with an increased number of cloud centers, the cloud centers can be efficiently managed by distributed management, without increasing the load of management. Furthermore, the scalability of the management system can be enhanced.

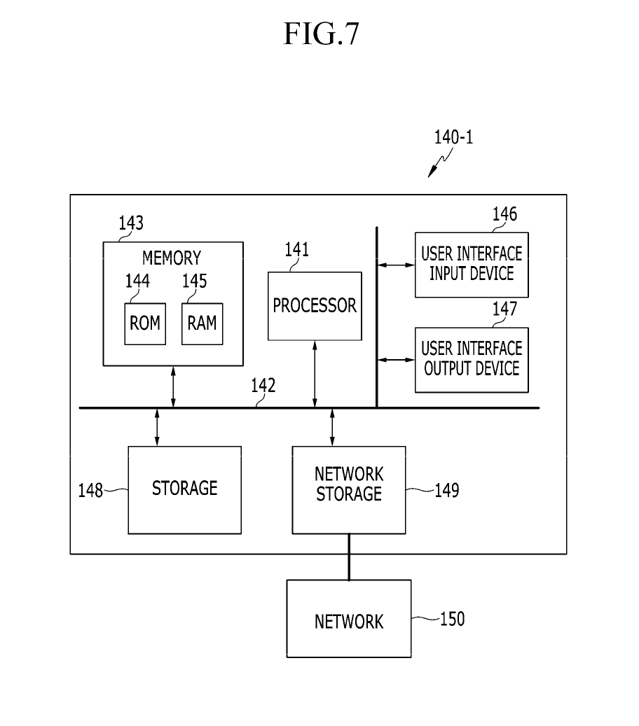

An embodiment of the present invention may be implemented in a computer system, e.g., as a computer readable medium. As shown in in FIG. 7, a computer system 140-1 may include one or more of a processor 141, a memory 143, a user input device 146, a user output device 147, and a storage 148, each of which communicates through a bus 142. The computer system 140-1 may also include a network interface 149 that is coupled to a network 150. The processor 141 may be a central processing unit (CPU) or a semiconductor device that executes processing instructions stored in the memory 143 and/or the storage 148. The memory 143 and the storage 148 may include various forms of volatile or non-volatile storage media. For example, the memory may include a read-only memory (ROM) 144 and a random access memory (RAM) 145.

Accordingly, an embodiment of the invention may be implemented as a computer implemented method or as a non-transitory computer readable medium with computer executable instructions stored thereon. In an embodiment, when executed by the processor, the computer readable instructions may perform a method according to at least one aspect of the invention.

The exemplary embodiments of the present invention are not implemented only according to the above-described device and/or method, but can be implemented through a program for realizing functions corresponding to the configuration of the exemplary embodiments of the present invention and a recording medium having the program stored thereon. Such implementation can be easily made by a skilled person in the art to which the present invention pertains from the above description of the exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for managing distributed cloud centers, the method comprising:
a global management system collecting individual resource information about the cloud centers from a plurality of local management systems that manage the distributed cloud centers;
the global management system selecting at least one cloud center, based on the collected individual resource information, according to users who have requested a cloud service; and
the global management system requesting cloud center resources while transmitting profile information in a resource container format to the local management systems that manage the selected cloud centers.

2. The method of claim 1, further comprising the local management system summarizing the individual resource information in a form required by the global management system, and transmitting the same to the global management system.

3. The method of claim 2, wherein, if there is any change, including the installation of new resources, addition or removal of resources, and presence of a defect in the cloud centers managed by the local management systems, the individual resource information comprises information related to such change.

4. The method of claim 2, wherein the individual resource information further comprises status information about the cloud centers.

5. The method of claim 1, wherein the profile information in the resource container format comprises VM (virtual machine) information for creating virtual servers and network setup information that includes one among a networking method for connection to other cloud centers and bandwidth.

6. The method of claim 1, wherein, in the selecting, at last one cloud center is selected by taking the regional characteristics of the service and the amounts of resources and locations of the cloud centers into account.

7. The method of claim 1, further comprising:
the global management system receiving resource utilization information from each local management system, and classifying the received resource utilization information;
the global management system analyzing and classifying the resource utilization information according to service users, cloud center, or resource containers, and storing the result in a global database; and
the global management system delivering monitoring information concerning the service provided, which contains the resource utilization information, to the administrator and the relevant user.

8. A method for managing distributed cloud centers, the method comprising:
a local management system managing at least one of the distributed cloud centers and generating individual resource information about the cloud center it manages;
the local management system summarizing the generated individual resource information in a preset form and transmitting the same to a global management system that manages the local management system;
the local management system receiving profile information in a resource container format from the global management system, in response to a cloud service request from each user; and
the local management system controlling the cloud center it manages based on the profile information to provide the cloud service to the user.

9. The method of claim 8, wherein the local management system manages only its own cloud center, and the global management system manages the cloud center indirectly through the local management system

10. The method of claim 8, wherein, in the generating of individual resource information, if there is any change, including the installation of new resources, addition or removal of resources, and presence of a defect in the cloud centers managed by the local management systems, the individual resource information comprises information related to such change.

11. The method of claim 8, wherein, in the providing of the cloud service, the local management system allocates the resources of the cloud center it manages in response to the cloud service request, based on the profile information, and notifies the global management system of the result of the resource allocation.

12. The method of claim 8, further comprising:
the local management system obtaining resource utilization information of each cloud center;
the local management system analyzing and classifying the resource utilization information according to service users, cloud centers, or resource containers; and
the local management system delivering monitoring information concerning the service based on the analyzed and classified information to the administrator and the relevant user.

13. A system for managing distributed cloud centers, the system comprising:
a plurality of local management systems that each manage at least one of the distributed cloud centers and generate individual resource information about the cloud center they manage; and
a global management system that collects individual resource information about the cloud centers from the plurality of local management systems, and requests cloud center resources while transmitting profile information in a resource container format to the local management systems according to users who have requested a cloud service,
wherein each local management system controls the cloud center it manages based on the profile information to provide the cloud service to the user.

14. The system of claim 13, wherein
the global management system comprises:
a resource information collection and management part that collects information about the cloud centers from the local management systems;
a global database that stores the collected information according to the cloud centers; and
a resource container generation part that generates profile information in a resource container format according to users who have requested the service, and requests resources while transmitting the same to the local management systems, the profile information including VM (virtual machine) information for creating virtual servers and network setup information that includes one among a networking method for connection to other cloud centers and bandwidth.

15. The system of claim 14, wherein the global management system further comprises an information classification part that receives resource utilization information transmitted from the local management systems and classifies and manages the received resource utilization information according to a preset classification system.

16. The system of claim 14, wherein the profile information further comprises load balancing information including a set value for load balancing, firewall information, and user network information concerning the type of networking used.

17. The system of claim 13, wherein
the local management system comprises:
a local management interface part that provides an interface with the outside;
an open control interface agent that interfaces with the global management system; and
a control and management part that manages the resources of the corresponding cloud center, monitors service use, and processes resource information and status information about the corresponding cloud center and provides the same to the global management system through the open control interface agent.

18. The system of claim 16, wherein, if there is any change in the resource information due to the installation of new resources, addition or removal of resources, and presence of a defect in the cloud center, the control and management part generates individual resource information containing related information, and summarizes the generated individual resource information in a form required by the global management system and provides the same to the global management system according to a preset cycle, whenever such change occurs, or in response to an instruction from the global management system.

19. The system of claim 16, wherein the control and management part gathers the information on utilization of resources of the cloud center for each piece of profile information in a resource container format, and transmits the same to the global management system.
